(19) United States
(12) Patent Application Publication
(10) Pub. No.: US 2011/0125655 A1
(43) Pub. Date: May 26, 2011

(54) LICENSE-RENEWAL MANAGEMENT APPARATUS LICENSE MANAGEMENT SYSTEM AND COMPUTER PROGRAM PRODUCT

(76) Inventors: Naoki CHIYO, Chiba (JP); Masami Nasu, Kanagawa (JP)

(21) Appl. No.: 12/951,511

(22) Filed: Nov. 22, 2010

(30) Foreign Application Priority Data
Nov. 25, 2009 (JP) 2009-267722

(51) Int. Cl. G06Q 50/00

(52) U.S. Cl. 705/310

(57) ABSTRACT

A license-renewal management apparatus, connected to an image forming apparatus and a license management server, includes: a storage unit that stores an identifier that identifies the image forming apparatus associated with payment information about whether usage charge for the software has been paid; a notification receiving unit that receives a notification of expiration of the license from the image forming apparatus; and a renewal-method setting unit that, on receiving the notification, causes automatic renewal of the license for the software installed onto the image forming apparatus to be stopped.

### CROSS-REFERENCE TO RELATED APPLICATIONS

The present application claims priority to and incorporates by reference the entire contents of Japanese Patent Application No. 2009-267722 filed in Japan on Nov. 25, 2009.

### BACKGROUND OF THE INVENTION

1. Field of the Invention

The present invention is directed to a license-renewal management apparatus that renews a license for application software after making determination that usage charge has been paid, a license management system, and a computer program product.

2. Description of the Related Art

Conventionally, techniques for causing a license management apparatus to renew a license granted to an image forming apparatus in response to a request for license renewal issued by the image forming apparatus have been widely used. For example, as a method for charging software usage charge, a usage-based charge method of charging usage charge depending on an amount or a period of use made of software service, or the like has been employed in some cases.

Methods for automatically renewing a license for application software installed onto an image processing apparatus have been developed. For instance, a method of automatically renewing a license by determining whether time of expiration of the license has come based on its expiration date is disclosed in, for instance, Japanese Patent Application Laid-open No. 2006-235963.

However, the automatic license renewal is performed by and between an image forming apparatus and a license management apparatus. Accordingly, a license could be renewed even when usage charge has not been paid yet because the license management apparatus does not hold information about whether the usage charge has been paid. This can result in an undesirable situation that the software is not deactivated while usage charge unpaid.

### SUMMARY OF THE INVENTION

It is an object of the present invention to at least partially solve the problems in the conventional technology.

According to an aspect of the present invention, there is provided a license-renewal management apparatus connected to an image forming apparatus and to a license management server that manages a license for software via a network, the license-renewal management apparatus comprising: a storage unit that stores an identifier that identifies the image forming apparatus associated with payment information about whether usage charge for the software has been paid; a notification receiving unit that receives a notification of expiration of the license from the image forming apparatus; and a renewal-method setting unit that, on receiving the notification, causes automatic renewal of the license for the software installed onto the image forming apparatus to be stopped.

According to another aspect of the present invention, there is provided a license management system comprising: an image forming apparatus; a license management server that manages a license for software installed onto the image forming apparatus; and a license-renewal management apparatus that manages renewal of the license, the license-renewal management apparatus being connected to the image forming apparatus and to the license management server via a network, wherein on detecting expiration of the license for the software installed onto the image forming apparatus, the image forming apparatus transmits a notification of expiration of the license to the license-renewal management apparatus, the software-renewal management apparatus includes: a storage unit that stores an identifier that identifies the image forming apparatus associated with payment information about whether usage charge for the software has been paid; a notification receiving unit that receives the notification from the image forming apparatus; a renewal-method setting unit that, on receiving the notification, causes automatic renewal of the license for the software installed onto the image forming apparatus to be stopped; a payment-information updating unit that obtains a latest version of the payment information and updates the payment information table stored in the storage unit to the latest version of the payment information obtained; a renewal-grant determining unit that obtains payment information associated with the identifier of the image forming apparatus to determine whether the usage charge has been paid based on the payment information and determines that the license is renewable upon determining that the usage charge has been paid; and a renewal requesting unit that requests the image forming apparatus to renew the license when the license is determined to be renewable, the image forming apparatus further includes a license requesting unit that, on receiving the request from the license-renewal management apparatus, transmits, to the license management server, a request for transmission of the license, and the software management server includes a license transmitting unit that, on receiving the request for transmission of the license from the image forming apparatus, transmits the license to the image forming apparatus.

According to still another aspect of the present invention, there is provided a license management system comprising: an image forming apparatus; an intermediary apparatus connected to the image forming apparatus via a network; a license management server that manages a license for software installed onto the image forming apparatus, the license management server being connected to the intermediary apparatus via the network; and a license-renewal management apparatus that manages renewal of the license, the license-renewal management apparatus being connected to the intermediary apparatus and to the license management server via the network, wherein on detecting expiration of the license for the software installed onto the image forming apparatus, the image forming apparatus transmits a notification of expiration of the license to the intermediary apparatus, the intermediary apparatus includes a communication unit that transfers the notification to the license-renewal management apparatus, the software-renewal management apparatus includes: a notification receiving unit that receives the notification from the intermediary apparatus; a renewal-method setting unit that, on receiving the notification, transmits an instruction to stop automatic renewal of the license for the installed software to the intermediary apparatus; a payment-information updating unit that, when the instruction to stop automatic renewal of the license has been transmitted, obtains a latest version of the payment information and updates the payment information stored in the storage unit to the latest version of the payment information having been obtained; a renewal-grant determining unit that refers to the payment information updated by the payment-information updating unit to obtain the payment information associated with the identifier of the image forming apparatus to determine whether the usage charge has been paid based on the payment information and determines that the license is renewable upon determining that the usage charge has been paid; and a renewal requesting unit that requests the intermediary apparatus to renew the license when the license is determined to be renewable, the intermediary apparatus further includes: a renewal-method setting unit that, on receiving the instruction to stop automatic renewal, causes automatic renewal of the license to be stopped; and a license requesting unit that, on receiving the request from the license-renewal management apparatus, transmits, to the license management server, a request for transmission of the license, and the license management server includes a license transmitting unit that, on receiving the request for transmission of the license from the image forming apparatus, transmits the license to the image forming apparatus.

According to still another aspect of the present invention, there is provided a computer program product comprising a non-transitory computer usable medium having computer readable program codes embodied in the medium that when executed causes a computer and a license management server connected to an image forming apparatus to execute a method comprising: storing an identifier that identifies the image forming apparatus associated with payment information about whether usage charge for the software has been paid into a storing unit; receiving a notification of expiration of the license from the image forming apparatus by a notification receiving unit; and on receiving the notification, causing automatic renewal of the license for the software installed onto the image forming apparatus to be stopped by a renewal-method setting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic network configuration diagram of a license management system 1 according to a first embodiment of the present invention;

FIG. 2 is a block diagram illustrating a functional configuration of a management apparatus 500;

FIG. 3 is a schematic explanatory diagram illustrating an example data structure of device information;

FIG. 4 is a schematic explanatory diagram illustrating an example of a payment information table;

FIG. 5 is a block diagram illustrating a functional configuration of a license management server 300;

FIG. 6 is a block diagram illustrating a functional configuration of an intermediary apparatus 200;

FIG. 7 is a sequence diagram illustrating flow of device-information obtaining processes;

FIG. 8 is a sequence diagram illustrating flow of license renewal processes;

FIG. 9 is a schematic explanatory diagram illustrating an example of updating of the payment information table;

FIG. 10 is a flowchart illustrating a process procedure for renewal-grant determination;

FIG. 11 is a schematic network configuration diagram of a license management system according to a second embodiment of the present invention;

FIG. 12 is a functional block diagram of an MFP 1600 according to the second embodiment;

FIG. 13 is a sequence diagram illustrating flow of license renewal processes; and

FIG. 14 is a block diagram illustrating a hardware configuration of an MFP 100 according to the first embodiment and the MFP 1600 according to the second embodiment.

### DETAILED DESCRIPTION OF THE PREFERRED EMBODIMENTS

Exemplary embodiments of the present invention are described in detail below with reference to the accompanying drawings. In the embodiments herein, an image processing apparatus is embodied as a multifunction peripheral (MFP) that combines a plurality of functions, such as a copier function, a facsimile function, and a printer function, in one casing. However, the image processing apparatus is not limited to such an MFP, and the present invention can be applied to any image processing apparatus, such as a facsimile apparatus or a scanner apparatus, onto which application software is installable.

### First Embodiment

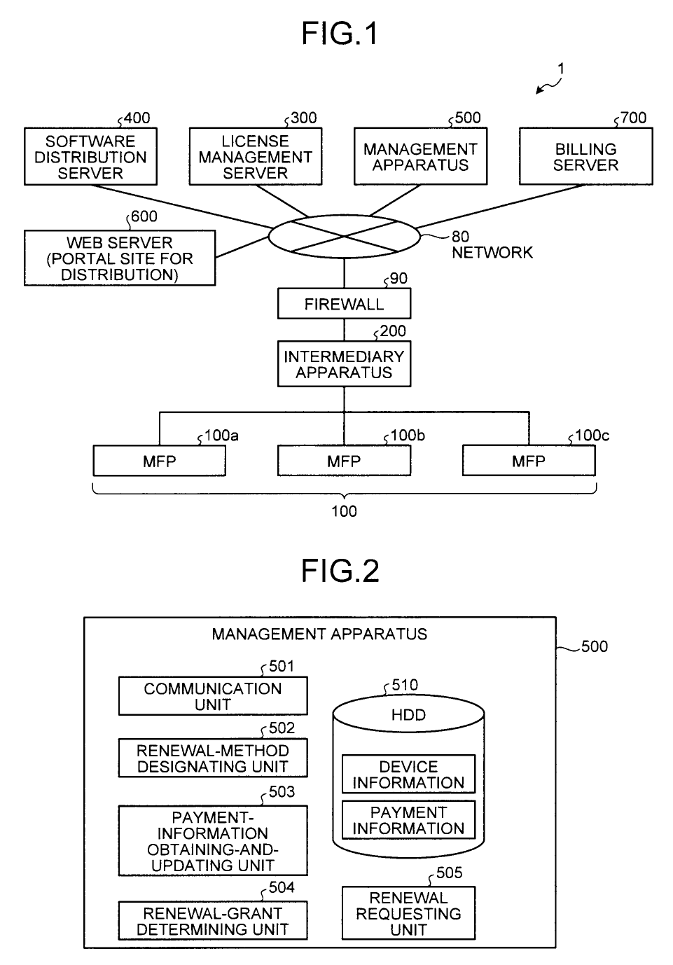

FIG. 1 is a block diagram of a license management system 1 according to a first embodiment of the present invention. As illustrated in FIG. 1, the license management system 1 includes an intermediary apparatus 200, a license management server 300, a software distribution server 400, a management apparatus 500 serving as a license-renewal management apparatus, a web server 600, and a billing server 700 that are connected to one another with a network 80, such as the Internet. A firewall 90 is provided between the intermediary apparatus 200 and the network 80. A plurality of MFPs, or more specifically MFPs 100a, 100b, and 100c (hereinafter, “MFP 100” is used to denote a not-specified one of the MFPs), are connected to the intermediary apparatus 200.

The firewall 90 monitors traffic passing across a boundary between the license management system and the outside world, and detects and blocks unauthorized electronic access so as to prevent unauthorized operation performed by a third party that has intruded into the intermediary apparatus 200 via an external network, such as a public line or the Internet.

The software distribution server 400 that stores software components, which are various application software packages to be executed by the MFP 100, is a server apparatus that distributes the software components to the MFP 100 via the intermediary apparatus 200.

The license management server 300 is an apparatus that manages licenses (authorizations) for application software components installed onto the MFP 100, and licenses (authorizations) for functions to be performed by the MFP 100 via the intermediary apparatus 200.

The web server 600 is a server apparatus that includes a portal site (hereinafter, “distribution portal site”) for distribution of software, such as application software. A user accesses the distribution portal site in the web server 600 from a personal computer (PC) (not shown), the MFP 100, or the like to purchase desired application software. When the user has purchased software from the web server 600, a device identifier (ID) of the MFP 100 specified as an installation target, onto which the purchased software is to be installed, and a product ID and a product key of the purchased software are transmitted together with a request for installation from the web server 600 to the management apparatus 500.

The management apparatus 500 remotely manages the MFP 100 via the intermediary apparatus 200. More specifically, the management apparatus 500 is a server apparatus placed in a service center of manufacturer, service provider, or the like of the MFP 100. On receiving the installation request from the web server 600, the management apparatus 500 accesses the software distribution server 400 to obtain a uniform resource locator (URL) of a location, from which a to-be-installed software component is to be obtained, and URLs of locations, from which dependent software components are to be obtained. The management apparatus 500 then refers to the device information about statuses of software components already installed onto the MFP 100, which is the installation target, to determine dependent software components that are necessary for the MFP 100 and transmits an installation request to the intermediary apparatus 200.

On receiving a request for renewing a license (hereinafter, “renewal request”) from the intermediary apparatus 200, the management apparatus 500 obtains information about payment of usage charge for the license from the billing server 700. When the management apparatus 500 has determined that the usage charge has been paid, the management apparatus 500 transmits a notification of license renewal grant to the intermediary apparatus 200.

The intermediary apparatus 200 is an apparatus that intermediates processing performed by and between the MFP 100, and the management apparatus 500 and the license management server 300. More specifically, the intermediary apparatus 200 collects device information about statuses of software components already installed onto the MFP 100 on an MFP-by-MFP basis at regular time intervals and transmits this MFP-by-MFP device information to the management apparatus 500.

The intermediary apparatus 200 transmits a request for a to-be-installed software component to a software distribution server (not shown) and receives the software component therefrom. The intermediary apparatus 200 also transmits a request for a license for the to-be-installed software component to the license management server 300 and receives the license therefrom. The intermediary apparatus 200 transmits, together with the thus-obtained software component and the license, a request for installation of the software component to the MFP 100, thereby causing the MFP 100 to install the to-be-installed software component.

On receiving a notification that license has expired (hereinafter, “license expiration notification”) from the MFP 100, the intermediary apparatus 200 transmits a renewal request to the management apparatus 500. On receiving a grant for license renewal from the management apparatus 500, the intermediary apparatus 200 obtains a license from the license management server 300 and instructs the MFP 100 to perform license renewal.

The billing server 700 calculates software usage charge based on the number of times the MFP 100 has used the software or counting information that indicates the number of prints produced by the MFP 100 by using the software and collects the usage charge from a user.

The MFP 100 is an apparatus that has a plurality of functions to serve as a copier, a facsimile, a printer, and the like and is connected to the intermediary apparatus 200 via a local network such as a local area network (LAN). FIG. 1 illustrates an example where three MFPs 100a, 100b, and 100c are connected to the network; however, the number of the MFPs is not limited to three, and the license management system 1 can include one, two, four, or more online MFPs. The MFP 100 includes an application-installation control unit that, on receiving a software component and a license together with a request for installation from the intermediary apparatus 200, performs installation of the software component specified in the request.

The management apparatus 500 is described in detail below. FIG. 2 is a block diagram illustrating a functional configuration of the management apparatus 500. As illustrated in FIG. 2, the management apparatus 500 includes a communication unit 501, a renewal-method designating unit 502, a payment-information obtaining-and-updating unit 503, a renewal-grant determining unit 504, and a hard disk drive (HDD) 510.

The communication unit 501 receives from the web server 600 an installation request that contains a device ID of the MFP 100 (hereinafter, “installation-target MFP 100”) specified by a user as installation target, and a product name, a product ID, and a product key of a to-be-installed software component specified by the user. The communication unit 501 also performs a function as a device-information receiving unit that receives device information about the MFP 100 from the intermediary apparatus 200 at regular time intervals and stores the device information in the HDD 510.

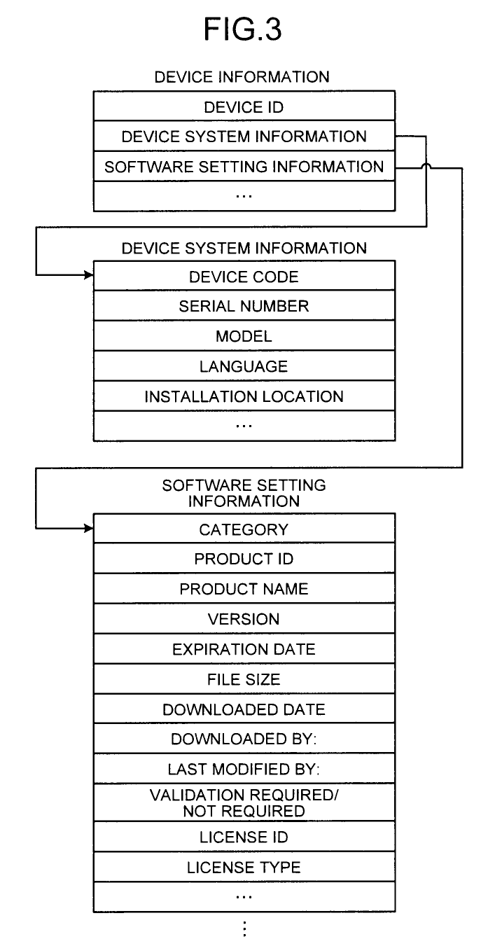

Meanwhile, the device information contains the device ID that identifies the MFP 100 uniquely, device system information that indicates a type of the MFP 100, and software setting information that is information about software component having already been installed onto the MFP 100 and that corresponds to installed-software information. FIG. 3 is a schematic explanatory diagram illustrating an example data structure of the device information.

As illustrated in FIG. 3, the device information is configured such that the device system information is further linked with a table of detailed information, while the software setting information is further linked with a table of detailed information about the software setting information. The software setting information is provided for each of software components installed onto the MFP 100 and linked to detailed information on software-component-by-software-component basis. Put another way, in a case where a plurality of software components have been installed onto the MFP 100, the device information contains a plurality of software setting information pieces, each of which is linked with a table of detailed information.

The detail information table of the device system information contains information about device code, serial number, model, language, installation location, and the like of the MFP 100 as presented in FIG. 3. The detail information table of the software setting information contains information about category, product ID that uniquely identifies the software component, product name, version, expiration date, license ID, and the like of the software component as presented in FIG. 3. Such device information as described above is stored in the HDD 510 for each of the MFPs 100, or, put another way, on a device-ID-by-device-ID basis.

Referring back to FIG. 2, the communication unit 501 receives a license expiration notification from the MFP 100 via the intermediary apparatus 200.

When the communication unit 501 has received the renewal request, the renewal-method designating unit 502 transmits an instruction to change setting for license renewal method of the MFP 100 from automatic renewal to manual renewal. Meanwhile, automatic license renewal is a feature that uniformly and automatically renews a license to a license with new expiration date when the license has expired. Manual license renewal is a feature that causes the management apparatus 500, on receiving a license expiration notification from the MFP 100, to make determination as to whether the license is renewable on a device-by-device basis and renew the license when the license is determined to be renewable.

The payment-information obtaining-and-updating unit 503 obtains payment information from the billing server 700 via the communication unit 501 to update payment information stored in the HDD 510. The payment information, which is information about payment statuses indicating whether usage charge for a license has been paid on a device-by-device basis, is stored in the HDD 510 in the form of a payment information table, in which device IDs are associated with the payment statuses.

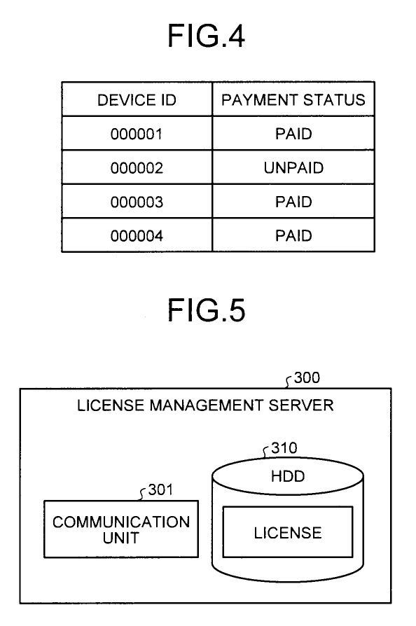

FIG. 4 is a schematic explanatory diagram illustrating an example of the payment information table. As illustrated in FIG. 4, in the payment information table, any one of “paid” indicating that usage charge for license has been paid and “unpaid” indicating that the usage charge is not paid yet is assigned to each of stored device IDs “000001” to “000004.”

Referring back to FIG. 2, the renewal-grant determining unit 504 determines whether the license is renewable based on the payment information updated by the payment-information obtaining-and-updating unit 503. More specifically, the renewal-grant determining unit 504 refers to payment status associated with a device ID of the device specified in the license expiration notification, and if the payment status is “paid,” the renewal-grant determining unit 504 determines that the license is renewable whereas if the payment status is “unpaid,” determines that the license is unrenewable.

If the renewal-grant determining unit 504 has determined that the license is renewable, the renewal requesting unit 505 transmits a request for license renewal to the device specified in the license expiration notification. More specifically, the renewal requesting unit 505 requests the intermediary apparatus 200 to obtain the license via the communication unit 501.

The license management server 300 is described in detail below. FIG. 5 is a block diagram illustrating a functional configuration of the license management server 300. As illustrated in FIG. 5, the license management server 300 includes a communication unit 301 and an HDD 310.

Licenses for software components installed onto the MFP 100 are stored in the HDD 310.

The communication unit 301 receives a request for transmission of a license from the intermediary apparatus 200 or the management apparatus 500 and, in response thereto, transmits the license to the intermediary apparatus 200 or the management apparatus 500.

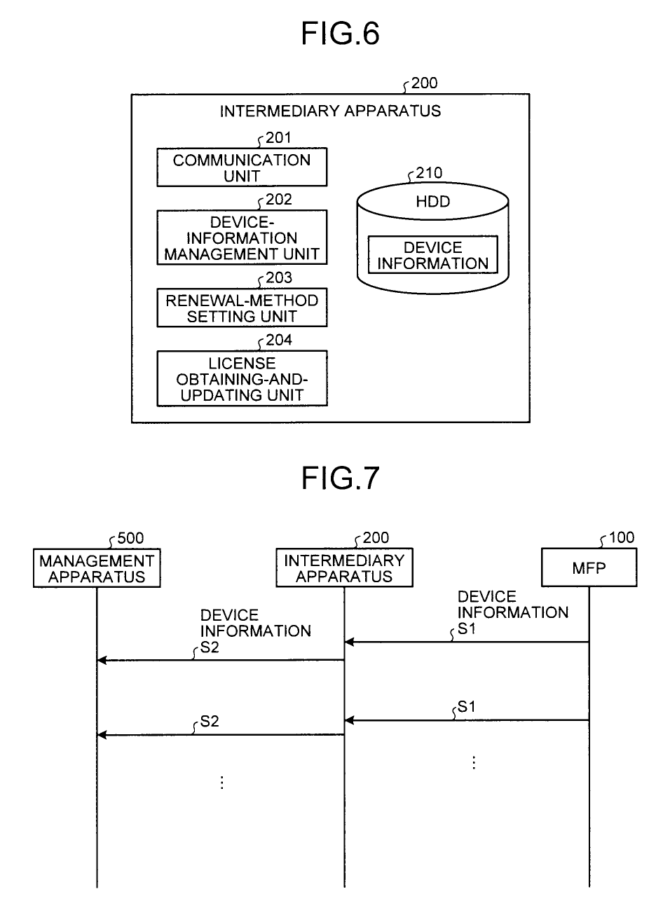

The intermediary apparatus 200 is described in detail below. FIG. 6 is a block diagram illustrating a functional configuration of the intermediary apparatus 200. As illustrated in FIG. 6, the intermediary apparatus 200 includes a communication unit 201, a device-information management unit 202, a renewal-method setting unit 203, a license obtaining-and-updating unit 204, and an HDD 210.

The communication unit 201 receives device information from the MFP 100 at regular time intervals, which corresponds to predetermined timing. The communication unit 201 stores the thus-received device information in the HDD 210 and simultaneously transmits the device information to the management apparatus 500. The communication unit 201 also receives a license expiration notification from the MFP 100 and transmits the license expiration notification to the management apparatus 500. The device-information management unit 202 maintains the device information stored in the HDD 210.

FIG. 7 is a sequence diagram illustrating flow of device information. As illustrated in FIG. 7, the intermediary apparatus 200 receives device information from the MFP 100 at regular time intervals (Step S1), and transmits the received device information to the management apparatus 500 at regular time intervals (Step S2).

Referring back to FIG. 6, the renewal-method setting unit 203 configures setting for license renewal method to be applied to the MFP 100. The license renewal method is set to any one of automatic renewal and manual renewal.

The license obtaining-and-updating unit 204 obtains a license from the license management server 300 and renews the license stored in the MFP 100 according to a renewal request transmitted from the management apparatus 500.

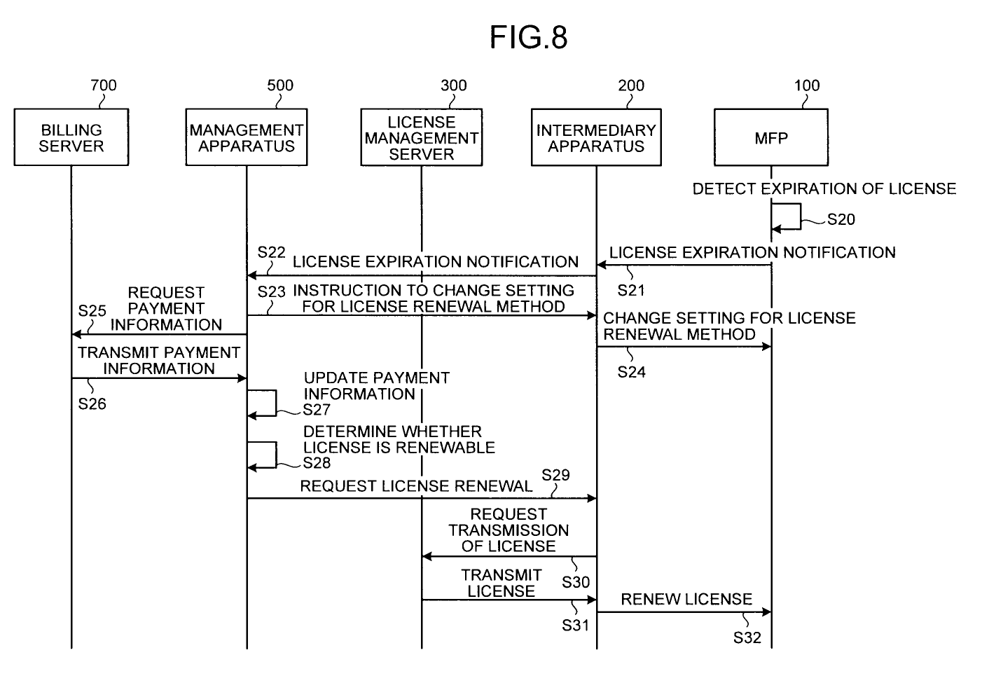

License renewal to be performed in the license management system 1 according to the first embodiment configured as described above is described below. FIG. 8 is a sequence diagram illustrating flow of license renewal processes according to the first embodiment.

On detecting expiration of a license (Step S20), the MFP 100 transmits a license expiration notification to the intermediary apparatus 200 (Step S21). On receiving the license expiration notification from the MFP 100, the intermediary apparatus 200 transmits the license expiration notification to the management apparatus 500 (Step S22).

On receiving the license expiration notification from the intermediary apparatus 200, the management apparatus 500 transmits, to the intermediary apparatus 200, an instruction to change the setting for license renewal method (Step S23). On receiving the instruction to change the setting for license renewal method, the intermediary apparatus 200 changes the setting for license renewal method of the MFP 100 (Step S24). More specifically, the intermediary apparatus 200 causes automatic license renewal that is currently applied to the MFP 100 to be stopped and changes the license renewal method to manual renewal.

On receiving the notification at Step S22, the management apparatus 500 requests the billing server 700 for payment information (Step S25). The billing server 700 transmits payment information to the management apparatus 500 (Step S26).

The management apparatus 500 updates payment information stored in the HDD 510 to the payment information transmitted from the billing server 700 (Step S27).

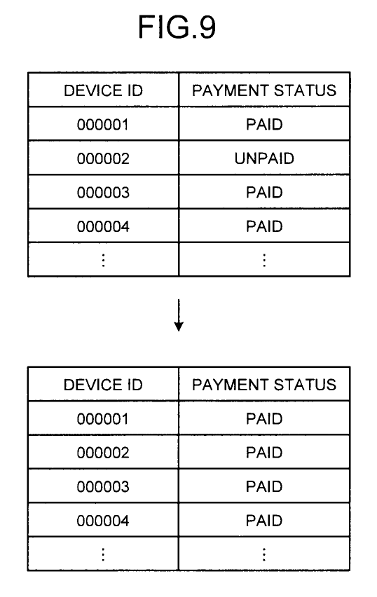

FIG. 9 is a schematic explanatory diagram illustrating an example of updating of the payment information table. The payment information table in the upper portion of FIG. 9 contains payment information stored in the HDD 510 at a point in time where the request for payment information is transmitted from the management apparatus 500 to the billing server 700. The payment information table in the downward portion of FIG. 9 contains payment information transmitted from the billing server 700 in response to the request for payment information and received by the management apparatus 500. On receiving the payment information from the billing server 700, the management apparatus 500 updates the payment information table stored in the HDD 510 and presented in the upper table of FIG. 9 to the payment information presented in the downward table of FIG. 9. This updating changes the payment status of the device ID “000002” from “unpaid” to “paid” as presented in FIG. 9. Alternatively, the management apparatus 500 can receive, of the payment information table, only payment information pertaining to the device ID “000002.”

The management apparatus 500 determines whether the license is renewable based on the updated payment information (Step S28).

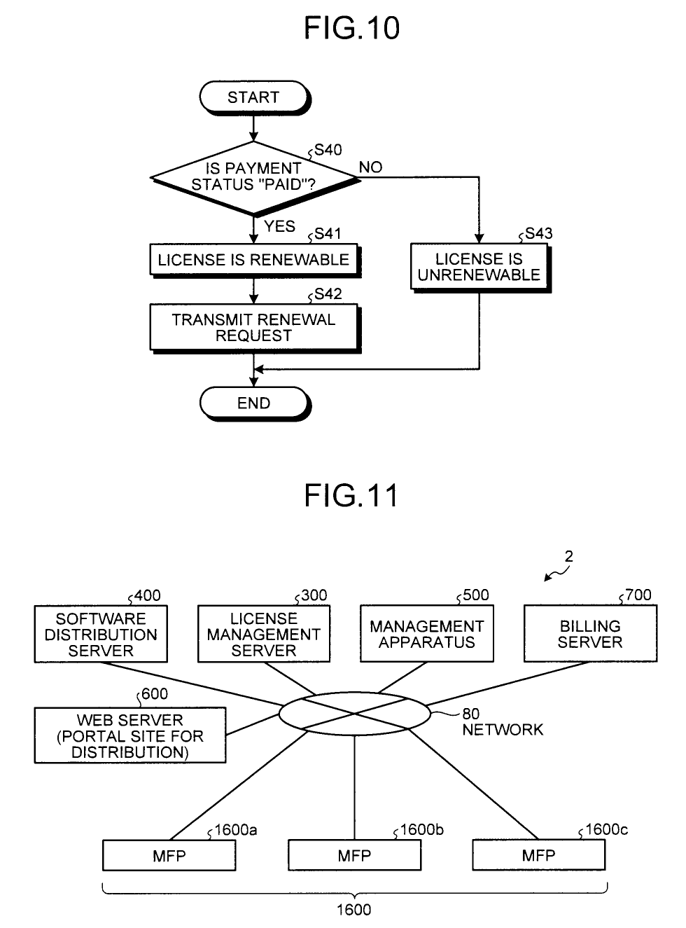

Processes to be performed to determine whether a license is renewable (hereinafter, “renewal-grant determination”) are described below. FIG. 10 is a flowchart illustrating a process procedure for the renewal-grant determination.

The management apparatus 500 refers to the updated payment information table to determine whether payment status associated with a device ID of the MFP 100 specified in the license expiration notification is “paid” (Step S40). If the payment status is “paid” (YES at Step S40), the management apparatus 500 determines that the license is renewable (Step S41), and transmits a renewal request (Step S42).

If the payment status is “unpaid” (NO at Step S40), the management apparatus 500 determines that the license is unrenewable (Step S43) and hence does not issue a renewal request.

If, at Step S28 in FIG. 8, a result of the determination about the payment status made based on the payment information table is “paid”, the management apparatus 500 determines that the license is renewable, and transmits the renewal request to the intermediary apparatus 200 (Step S29).

On receiving the renewal request from the management apparatus 500, the intermediary apparatus 200 transmits, to the license management server 300, a request for transmission of the license (Step S30). On receiving the request for transmission of the license from the intermediary apparatus 200, the license management server 300 transmits the license to the intermediary apparatus 200 (Step S31).

On receiving the license from the license management server 300, the intermediary apparatus 200 transmits the received license to the MFP 100 so that the license of the MFP 100 is renewed (Step S32).

As described above, according to the first embodiment, on receiving a license expiration notification, the management apparatus 500 receives a latest version of the payment information pertaining to the MFP 100 specified in the license expiration notification from the billing server 700 and transmits a renewal request after making determination that usage charge has been paid. This prevents license, for which usage charge is not paid yet, from being renewed.

In the first embodiment, the configuration, in which the management apparatus 200 that has received a renewal request obtains a license from the license management server 300 and transmits the license to the MFP 100, is employed; however, another configuration can alternatively be employed. For instance, a configuration, in which the management apparatus 500 obtains a license from the license management server 300 and transmits the license together with a renewal request to the intermediary apparatus 200, can be employed.

### Second Embodiment

In the license management system 1 according to the first embodiment, the management apparatus 500 receives a license expiration notification from the MFP 100 via the intermediary apparatus 200 and transmits a renewal request to the MFP 100 via the intermediary apparatus 200. In contrast, in a second embodiment, the management apparatus 500 directly carries out communications with the MFP 100, not via the intermediary apparatus 200.

FIG. 11 is a schematic network configuration diagram of a license management system 2 according to the second embodiment. As illustrated in FIG. 11, the license management system 2 according to the second embodiment includes the management apparatus 500, the billing server 700, the software distribution server 400, the license management server 300, the web server 600, and MFPs 1600 (1600a, 1600b, and 1600c) that are connected to one another with the network 80 but does not include the intermediary apparatus 200.

The configurations of the software distribution server 400, the license management server 300, the web server 600, and the billing server 700 are similar to those of the first embodiment. However, in the second embodiment, the management apparatus 500 receives device information directly from the MFP 1600 and transmits a renewal request directly to the MFP 1600.

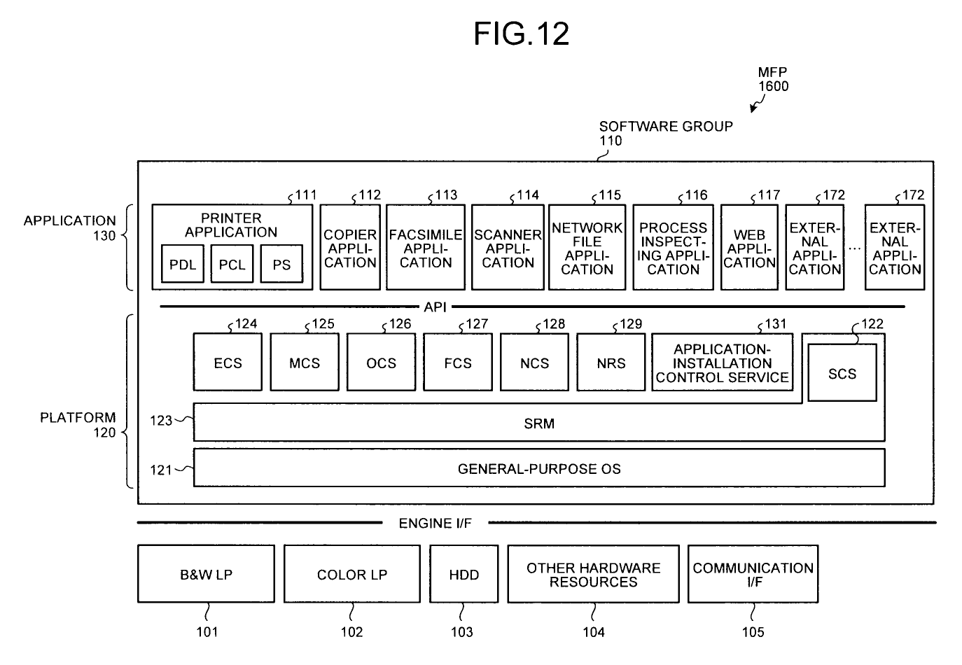

The MFP 1600 is described below. FIG. 12 is a block diagram of the MFP 1600 according to the second embodiment. As illustrated in FIG. 12, the MFP 1600 includes a black-and-white laser printer (B&W LP) 101, a color laser printer (color LP) 102, an HDD 103, other hardware resources 104, such as a scanner, a facsimile, and memory, a communication interface (I/F) 105, and a software group 110 that includes a platform 120 and applications 130.

In the MDP 1600 according to the second embodiment, the HDD 103 stores device information, an application software package downloaded from the software distribution server 400, a firmware package, package information, instructions serving as operation instructions for installation process, and a license file related to downloaded application from the license management server 300. Progress of installation process is also recorded in the HDD 103.

The platform 120 includes control services that parse a request from application and issue a resource request for a hardware resource, a system resource manager (SRM) 123 that manages one or more hardware resources and arbitrates resource requests from the control service, and a general-purpose operating system (OS) 121.

The control services include a plurality of service modules, or more specifically, a system control service (SCS) 122, an engine control service (ECS) 124, a memory control service (MCS) 125, an operation-panel control service (OCS) 126, a facsimile control service (FCS) 127, a network control service (NCS) 128, a new remote service (NRS) 129, and an application-installation control service 131. The platform 120 includes an application program interface (API) that allows receipt of processing request from the applications 130 by using functions defined in advance.

The general-purpose OS 121, which is a general-purpose operating system such as UNIX (registered trademark), executes software programs of the platform 120 and the applications 130 concurrently as parallel processes.

The SRM 123 performs a process for system control and resource management in cooperation with the SCS 122. More specifically, the SRM 123 performs a process for arbitration, execution, and control according to a request transmitted from an upper layer that uses hardware resource, such as an engine of a scanner unit, a printer unit, or the like, memory, an HDD file, or a host input/output (I/O) (e.g., a Centronics-compatible I/F, a network I/F, an IEEE 1394 (the Institute of Electrical and Electronics Engineers 1394) I/F, or an RS-232C I/F).

More specifically, the SRM 123 determines whether the requested hardware resource is available (i.e., whether the requested hardware resource is currently used for another request), and if the requested hardware resource is available, sends a notification that the requested hardware resource is available to the upper layer. The SRM 123 also arranges, in response to a request from the upper layer, a schedule for utilization of hardware resource and directly performs a requested operation (e.g., memory allocation, file creation, or causing a printer engine to perform paper feeding and image forming).

The SCS 122 performs a process for application management, control of an operating unit, displaying system-related screens, indication with light-emitting diodes (LEDs), resource management, control of application interruption, and the like.

The ECS 124 performs a process for engine control of the hardware resources 104 that include the B&W LP 101, the color LP 102, the scanner, and the facsimile.

The MCS 125 performs a process for allocation and release of image memory, utilization of the HDD, compression and decompression of image data, and the like.

The FCS 127 performs a process for provision of an API that allows facsimile transmission to and reception from each application layer of a system controller by using public switched telephone network (PSTN) or integrated services digital network (ISDN) network, storing and retrieving facsimile data in and from a backup static-RAM (BKM) that manages various facsimile data pieces, scanning for facsimile transmission, printing of received facsimile data, and transmission and reception by using combined functions.

The NCS 128 processes provision of services that are common among applications that require network I/O, or more specifically, intermediates allocation of data pieces, which are received via the network by using various protocols, to the applications and data transmission from the applications to the network.

The OCS 126 performs a process for control of an operation panel (control panel) that serves as an interface between an operator (user) and control of the apparatus. When a key is pressed (or touched) on the operation panel, the OCS 126 recognizes it as a key event. The OCS 126 includes a portion serving as an OCS process that transmits a key event function corresponding to the thus-recognized key to the SCS 122 and a portion serving as an OCS library, in which rendering functions that cause various images to be rendered and displayed on the operation panel according to a request from any one of the applications 130 and the control services, other control functions for the operation panel, and the like are stored in advance. The OCS library is implemented as being linked with various modules of the applications 130 and the control services. The entire OCS 126 can be configured so as to operate as the OCS process. Alternatively, the entire OCS 126 can be configured as the OCS library.

The application-installation control service 131 performs a process of transmitting device information that contains information about software, such as application installed onto the MFP 1600, and information about device, to the management apparatus 500 at regular time intervals. The application-installation control service 131 performs a process, on receiving an installation request from the management apparatus 500, of transmitting a distribution request for a to-be-installed software component specified by a product ID in the installation request to the software distribution server 400, of receiving the to-be-installed software component from the software distribution server 400, and of installing the to-be-installed software component. The application-installation control service 131 also performs a process, on receiving the installation request from the management apparatus 500, of transmitting a request for a license specified by the product ID in the installation request to the license management server 300, and of obtaining the license from the license management server 300.

On detecting expiration of a license for an installed software component, the application-installation control service 131 performs a process of transmitting a license expiration notification to the management apparatus 500. On receiving a renewal request from the management apparatus 500, the application-installation control service 131 obtains a license from the license management server 300 and performs license renewal.

The NRS 129 performs a process for a function related to device remote management, such as data conversion for transmission and reception of data via the network, via a network and a scheduler function.

The applications 130 include a printer application 111 that is an application for a printer that has a page description language (PDL) and a post script (PS), a copier application 112 that is an application for a copier, a facsimile application 113 that is an application for a facsimile, a scanner application 114 that is an application for a scanner, a network file application 115 that is an application for a network file, a process inspecting application 116 that is an application for process inspection, and a web application 117 that serves as a web server (hypertext transfer protocol (http) server) and displays various screens on a web browser that is run on a client terminal.

Each of processes performed by the applications 130 and the processes performed by the control services provides a user service related to image forming operation to be performed by a copier, a printer, a scanner, a facsimile, or the like by performing function call and return value transmission in response to the function call and exchanging messages for inter-process communications.

As described above, the MFP 1600 according to the second embodiment includes the plurality of applications 130 and the plurality of control services, each of which is run as a process. One or multiple threads are generated in each of the processes, in which the threads are run concurrently. The control services provide common services to the applications 130. Accordingly, a large number of processes are performed concurrently and threads are run concurrently while the processes and the threads carry out inter-process communications for cooperation with one another, thereby providing the user service related to image forming operation performed by the copier, the printer, the scanner, the facsimile, or the like.

The MFP 1600 is configured such that a third party, such as a customer or a third vendor, of the MFP 1600 can develop an external application 172 and install the external application 172 on an application layer, which is an upper layer of a control service layer. The external application 172 can be downloaded from the software distribution server 400 and installed by the application-installation control service 131. FIG. 12 illustrates a situation where applications are run.

The plurality of processes of the application programs 130 and the plurality of processes of the control services are run in the MFP 1600 according to the second embodiment; however, alternatively, the MFP 1600 can be configured such that a single process of the application programs 130 and a single process of the control services are run on the MFP 1600. Addition to or deletion of an application from the applications 130 can be performed on an application-by-application-basis. Put another way, as described above, the external application 172 can be installed onto or uninstalled from the MFP 1600.

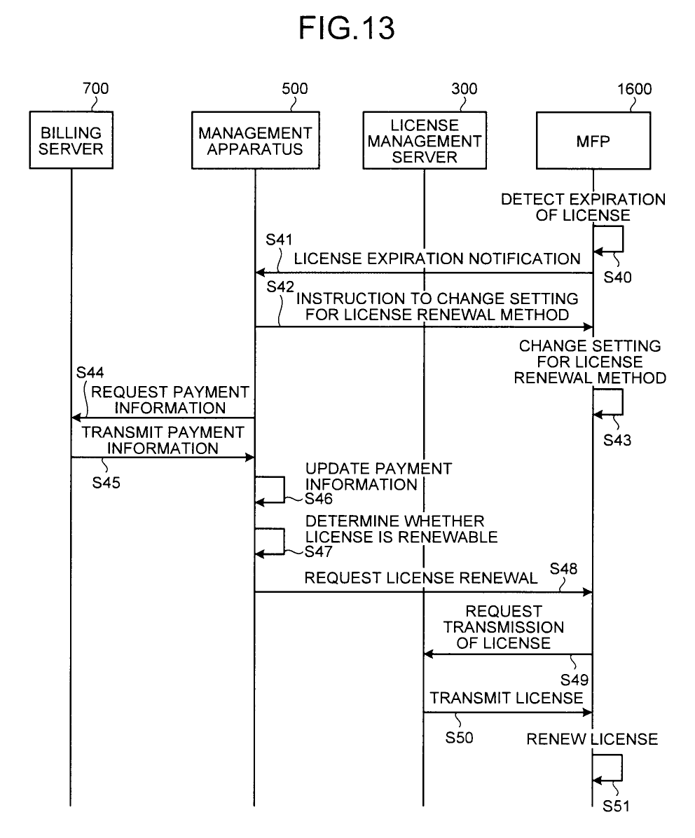

License renewal to be performed in the license management system 2 according to the second embodiment configured as described above is described below. FIG. 13 is a sequence diagram illustrating flow of license renewal processes according to the second embodiment.

On detecting expiration of a license (Step S40), the MFP 1600 transmits a license expiration notification to the management apparatus 500 (Step S41). On receiving the license expiration notification from the MFP 1600, the management apparatus 500 transmits an instruction to change setting for license renewal method to the MFP 1600 (Step S42). On receiving the instruction to change the setting for license renewal method, the MFP 1600 changes the setting for license renewal method (Step S43). More specifically, the intermediary apparatus 200 changes the license renewal method from automatic license renewal, which is currently applied to the MFP 1600, to manual renewal.

Operations to be performed from Step S44, at which payment information is requested, to S47, at which renewal grant determination is made, are performed in a manner similar to those in the first embodiment. When, as a result of the renewal grant determination, the license is determined to be renewable, the management apparatus 500 transmits a renewal request to the MFP 1600 (Step S48).

On receiving the renewal request, the MFP 1600 transmits, to the license management server 300, a request for transmission of the license (Step S49). On receiving the request for transmission of the license from the MFP 1600, the license management server 300 transmits the license to the MFP 1600 (Step S50).

On receiving the license from the license management server 300, the MFP 1600 renews the license stored in the HDD 103 (Step S51).

As described above, according to the second embodiment, on receiving a license expiration notification, the management apparatus 500 receives a latest version of the payment information pertaining to the MFP 1600 specified in the license expiration notification from the billing server 700 and issues a renewal request after making determination that usage charge has been paid. This prevents license, for which usage charge is not paid yet, from being renewed.

In the second embodiment, the configuration, in which MFP 1600 that has received a renewal request obtains a license from the license management server 300 and performs license renewal, is employed; however, another configuration can be employed. For instance, a configuration, in which the management apparatus 500 obtains a license from the license management server 300 and transmits the license together with a renewal request to the MFP 1600, can alternatively by employed.

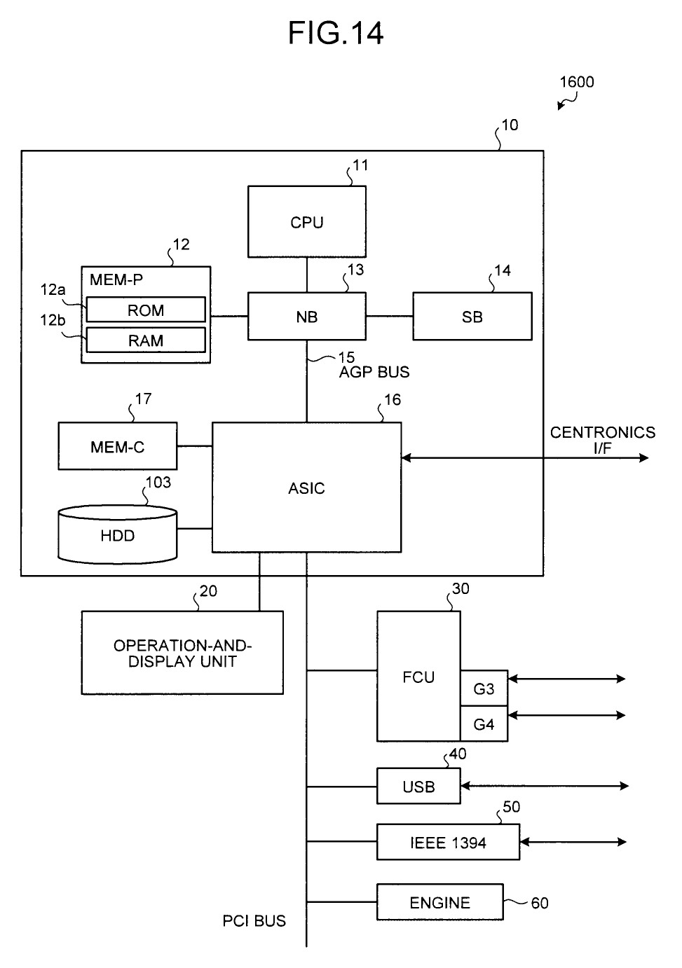

FIG. 14 is a block diagram illustrating a hardware configuration of the MFP 1600 according to the first and second embodiments. As illustrated in FIG. 14, the MFP 1600 includes a controller 10 and an engine 60 that are connected together with a peripheral component interface (PCI) bus. The controller 10 is a controller that controls the overall MFP 1600, rendering, communications, and inputs entered via an operating unit (not shown). The engine 60 is a printer engine or the like that is connectable to the PCI bus. Examples of the engine 60 include a monochrome plotter, a one-drum color plotter, a four-drum color plotter, a scanner unit, and a facsimile unit. The engine 60 includes, in addition to what is called an engine section such as the plotter, an image processing section that performs error diffusion, gamma conversion, and the like.

The controller 10 includes a central processing unit (CPU) 11, a north bridge (NB) 13, a system memory (hereinafter, “MEM-P”) 12, a south bridge (SB) 14, a local memory (hereinafter, “MEM-C”) 17, an application-specific integrated circuit (ASIC) 16, and the HDD 103, in which an accelerated graphics port (AGP) bus 15 connects between the NB 13 and the ASIC 16. The MEM-P 12 further includes read only memory (ROM) 12a and random access memory (RAM) 12b.

The CPU 11 that controls the overall MFP 1600 includes a chip set that includes the NB 13, the MEM-P 12, and the SB 14. The CPU 11 is connected to another device via the chip set.

The NB 13 is a bridge for connecting the CPU 11 to the MEM-P 12, the SB 14, and the AGP 15. The NB 13 includes a PCI master, an AGP target, and a memory controller that controls reading and writing from and to the MEM-P 12 and the like.

The MEM-P 12 that includes the ROM 12a and the RAM 12b is a system memory for use as memory for storing program instructions and data, for loading program instructions and data thereinto, for use in rendering for the printer, and the like. The ROM 12a is read only memory for use as memory for storing program instructions and data. The RAM 12b is writable and readable memory for use as memory for loading program instructions and data thereinto, as memory for use in rendering for the printer, and the like.

The SB 14 is a bridge for connecting the NB 13 to a PCI device and peripheral devices. The SB 14 is connected to the NB 13 via the PCI bus, to which a network I/F and the like are also connected.

The ASIC 16, which is an integrated circuit (IC) for use in image processing, includes a hardware component for the image processing and functions as a bridge that connects the AGP 15, the PCI bus, an HDD 103, and the MEM-C 17 with each other. The ASIC 16 includes a PCI target and an AGP master, an arbiter (ARB) serving as the core for the ASIC 16, a memory controller that controls the MEM-C 17, a plurality of direct memory access controllers (DMACs) that performs data processing related to rotation of image data and the like by hardware logic, and a PCI unit that performs data transfer to and from the engine 60 via the PCI bus. A facsimile control unit (FCU) 30, a universal serial bus (USB) 40, and an IEEE 1394 I/F 50 are connected to the ASIC 16 via the PCI bus. An operation-and-display unit 20 is directly connected to the ASIC 16.

The MEM-C 17 is local memory for use as a copy image buffer and a code buffer. The HDD 103 is a storage for storing image data, program instructions, font data, and forms.

The AGP 15 is a bus interface for a graphics accelerator card introduced to speed up graphics operations and allows direct access to the MEM-P 12 with a high throughput, thereby speeding up operations related to the graphic accelerator card.

License renewal program instructions to be executed by the MFP 1600 can be provided as being preinstalled in ROM or the like.

The license renewal program instructions to be executed by the MFP 1600 according to the embodiment can be provided as being recorded in a computer-readable recording medium such as a compact disc-ROM (CD-ROM), a flexible disk (FD), a CD recordable (CD-R), or a digital versatile disk (DVD) in an installable or executable format.

The license renewal program instructions to be executed by the MFP 1600 according to the embodiment can be stored in a computer connected to a network such as the Internet so that the program instructions are provided by downloading via the network. The license renewal program instructions to be executed by the MFP 1600 according to the embodiment can be provided or distributed via a network such as the Internet.

The license renewal program instructions to be executed by the MFP 1600 according to the embodiment have a module structure made of the units described above (the renewal-method designating unit, the payment-information obtaining-and-updating unit, the payment-information updating unit, and the renewal requesting unit). On being implemented as an actual hardware, the CPU (processor) reads license renewal program from the ROM and executes the license renewal program to load the units on a main memory device, thereby generating the renewal-method designating unit, the payment-information obtaining-and-updating unit, the payment-information updating unit, and the renewal requesting unit on the main memory device.

Although the embodiment has been described with regard to installation of application software onto the MFP 1600, this technique is applicable to software other than application software.

The management apparatus 500, the software distribution server 400, the license management server 300, and the web server 600 according to the embodiments each has a hardware configuration that utilizes a typical computer and includes a control device such as a CPU, a storage device such as ROM and/or RAM, an external storage device such as an HDD and/or a CD drive, a display device, and an input device such as a keyboard and/or a mouse.

Renewal-grant determination program instructions to be executed by the management apparatus 500 according to the embodiments can be provided as being recorded in a computer-readable recording medium, such as a CD-ROM, an FD, a CD-R, or a DVD, in an installable or executable format.

The renewal-grant determination program instructions to be executed by the management apparatus 500 according to the embodiments can be stored in a computer connected to a network such as the Internet so that the program instructions are provided by downloading via the network. The renewal-grant determination program instructions to be executed by the management apparatus 500 according to the embodiments can be provided or distributed via a network such as the Internet.

The renewal-grant determination program instructions to be executed by the management apparatus 500 according to the embodiments can be provided as being installed in ROM or the like in advance.

The renewal-grant determination program instructions to be executed by the management apparatus 500 according to the embodiments have a module structure made of the units of the functional configurations described above. From the viewpoint of actual hardware, the CPU (processor) reads the software distribution program from the storage medium and executes the software distribution program to load the units on a main memory device, thereby generating the units on the main memory device.

According to an aspect of the present invention, when usage charge for a license is not paid yet, renewal of the license can be advantageously prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A license-renewal management apparatus connected to an image forming apparatus and to a license management server that manages a license for software via a network, the license-renewal management apparatus comprising:
a storage unit that stores an identifier that identifies the image forming apparatus associated with payment information about whether usage charge for the software has been paid;
a notification receiving unit that receives a notification of expiration of the license from the image forming apparatus; and
a renewal-method setting unit that, on receiving the notification, causes automatic renewal of the license for the software installed onto the image forming apparatus to be stopped.

2. The license-renewal management apparatus according to claim 1, further comprising:
a payment-information updating unit that obtains a latest version of the payment information and updates the payment information stored in the storage unit to the latest version of the payment information obtained;
a renewal-grant determining unit that obtains the payment information associated with the identifier of the image forming apparatus, from which the notification has been transmitted, to determine whether the usage charge has been paid based on the payment information, and to determine that the license is renewable upon determining that the usage charge has been paid; and
a renewal requesting unit that requests the image forming apparatus to renew the license when the license is determined to be renewable.

3. The license-renewal management apparatus according to claim 1, wherein the notification receiving unit receives the notification from an intermediary apparatus,
the intermediary apparatus being connected to the image forming apparatus with the network and, on receiving the notification from the image forming apparatus, transmitting the notification to the license management apparatus.

4. The license-renewal management apparatus according to claim 2, wherein the renewal-method setting unit causes the automatic renewal of the license for the software installed onto the image forming apparatus to be stopped via an intermediary apparatus that is connected to the image forming apparatus via the network.

5. The license-renewal management apparatus according to claim 1, wherein the payment-information updating unit obtains the payment information from a billing server that maintains information about whether the usage charge has been paid.

6. A license management system comprising:
an image forming apparatus;
a license management server that manages a license for software installed onto the image forming apparatus; and
a license-renewal management apparatus that manages renewal of the license, the license-renewal management apparatus being connected to the image forming apparatus and to the license management server via a network, wherein
on detecting expiration of the license for the software installed onto the image forming apparatus, the image forming apparatus transmits a notification of expiration of the license to the license-renewal management apparatus,
the software-renewal management apparatus includes:
a storage unit that stores an identifier that identifies the image forming apparatus associated with payment information about whether usage charge for the software has been paid;
a notification receiving unit that receives the notification from the image forming apparatus;
a renewal-method setting unit that, on receiving the notification, causes automatic renewal of the license for the software installed onto the image forming apparatus to be stopped;
a payment-information updating unit that obtains a latest version of the payment information and updates the payment information table stored in the storage unit to the latest version of the payment information obtained;
a renewal-grant determining unit that obtains payment information associated with the identifier of the image forming apparatus to determine whether the usage charge has been paid based on the payment information and determines that the license is renewable upon determining that the usage charge has been paid; and
a renewal requesting unit that requests the image forming apparatus to renew the license when the license is determined to be renewable,
the image forming apparatus further includes a license requesting unit that, on receiving the request from the license-renewal management apparatus, transmits, to the license management server, a request for transmission of the license, and
the software management server includes a license transmitting unit that, on receiving the request for transmission of the license from the image forming apparatus, transmits the license to the image forming apparatus.

7. A license management system comprising:
an image forming apparatus;
an intermediary apparatus connected to the image forming apparatus via a network;
a license management server that manages a license for software installed onto the image forming apparatus, the license management server being connected to the intermediary apparatus via the network; and
a license-renewal management apparatus that manages renewal of the license, the license-renewal management apparatus being connected to the intermediary apparatus and to the license management server via the network, wherein
on detecting expiration of the license for the software installed onto the image forming apparatus, the image forming apparatus transmits a notification of expiration of the license to the intermediary apparatus,
the intermediary apparatus includes a communication unit that transfers the notification to the license-renewal management apparatus,
the software-renewal management apparatus includes:
a notification receiving unit that receives the notification from the intermediary apparatus;
a renewal-method setting unit that, on receiving the notification, transmits an instruction to stop automatic renewal of the license for the installed software to the intermediary apparatus;
a payment-information updating unit that, when the instruction to stop automatic renewal of the license has been transmitted, obtains a latest version of the payment information and updates the payment information stored in the storage unit to the latest version of the payment information having been obtained;
a renewal-grant determining unit that refers to the payment information updated by the payment-information updating unit to obtain the payment information associated with the identifier of the image forming apparatus to determine whether the usage charge has been paid based on the payment information and determines that the license is renewable upon determining that the usage charge has been paid; and
a renewal requesting unit that requests the intermediary apparatus to renew the license when the license is determined to be renewable,
the intermediary apparatus further includes:
a renewal-method setting unit that, on receiving the instruction to stop automatic renewal, causes automatic renewal of the license to be stopped; and
a license requesting unit that, on receiving the request from the license-renewal management apparatus, transmits, to the license management server, a request for transmission of the license, and
the license management server includes a license transmitting unit that, on receiving the request for transmission of the license from the image forming apparatus, transmits the license to the image forming apparatus.

8. A computer program product comprising a non-transitory computer usable medium having computer readable program codes embodied in the medium that when executed causes a computer and a license management server connected to an image forming apparatus to execute a method comprising:
storing an identifier that identifies the image forming apparatus associated with payment information about whether usage charge for the software has been paid into a storing unit;
receiving a notification of expiration of the license from the image forming apparatus by a notification receiving unit; and
on receiving the notification, causing automatic renewal of the license for the software installed onto the image forming apparatus to be stopped by a renewal-method setting unit.
